(19) United States
(12) Patent Application Publication
(10) Pub. No.: US 2007/0095409 A1
(43) Pub. Date: May 3, 2007

(54) Pneumatic wrench

(76) Inventor: Li-Hsueh Chen, Taichung (TW)

Correspondence Address: KUO-HSIUNG CHIU, 13F., NO.23, JIUN-HO STREET, PEITUN DISTRICT, TAICHUNG, 406, TW

(21) Appl. No.: 11/262,429

(22) Filed: Oct. 31, 2005

(51) Int. Cl. F16K 11/074

(52) U.S. Cl. 137/625.21

(57) ABSTRACT

A pneumatic wrench having a main body, a cylinder, an arresting device, a bearing, an air control hood and an adjusting knob, whereby the air control hood is screwed to a rear side of the cylinder receptacle of the main body, thereby fixing the cylinder, the arresting device and the bearing in place and sealing the cylinder receptacle of the main body, and the air control hood further includes an air intake channel and two corresponding air guide channels that work in cooperation with the adjusting knob having air control channels for controlling the path of and the rate of the air flow in admission into or exhaust out of the cylinder, thereby ensuring an effective control of the rotational direction and torque of an action end of the main body.

### BACKGROUND OF THE INVENTION

1. Fields of the Invention

The invention relates to a pneumatic wrench, and more particularly, to a pneumatic wrench having a simple assembly structure and an excellent application value.

2. Description of the Related Art

Most of pneumatic wrenches of the same art include a main body, a cylinder, an arresting device, a bearing, an air control element, a sealing hood and an adjusting element. Different pneumatic wrenches could have variation in design; however, the total amount of their components doesn't have much difference.

It is well-known that the fabrication and assembly of one product could be more cost-intensive and labor-intensive when this product has more components. Meanwhile, the problem of adaptability among different components easily arises when more components are employed. Besides, more defects could be created as well, thereby affecting the product quality.

### SUMMARY OF THE INVENTION

It is a primary object of the invention is to provide a pneumatic wrench that can be fabricated with lower cost, for example, by combining two or more components in a single one for achieving the economic benefit and enhancing the product quality.

In order to achieve the above-mentioned object, the air control element and the sealing hood of the prior art are combined to be a new component that is named “air control hood”. The air control hood is screwed to a rear side of the cylinder receptacle of the main body, thereby fixing a cylinder, an arresting device and a bearing in place and sealing a cylinder receptacle of a main body. Meanwhile, the air control hood further includes an air intake channel and two corresponding air guide channels that work in cooperation with an adjusting knob having air control channels for controlling the path of and the rate of the air flow in admission into or exhaust out of the cylinder, thereby ensuring an effective control of the rotational direction and torque of an action end of the main body.

### BRIEF DESCRIPTION OF THE DRAWINGS

The accomplishment of this and other objects of the invention will become apparent from the following description and its accompanying drawings of which:

FIG. 1 is a perspective exploded view of a preferred embodiment of the invention;

FIG. 2 is a perspective view of the preferred embodiment of the invention;

FIG. 3 is a cutaway view of the partial assembly of the preferred embodiment of the invention;

FIG. 4 is a side view of an adjusting knob of the invention;

FIG. 5 is a cutaway view taken along the line A-A of FIG. 4;

FIG. 6 is a side view of an air control hood of the invention;

FIG. 7 is a cutaway view taken along the line B-B of FIG. 6;

FIG. 8 is a front view of the air control hood of the invention;

FIG. 9 is a cutaway view taken along the line C-C of FIG. 8; and

FIG. 10 is a rear view of the air control hood of the invention.

### DETAILED DESCRIPTION OF THE PREFERRED EMBODIMENT

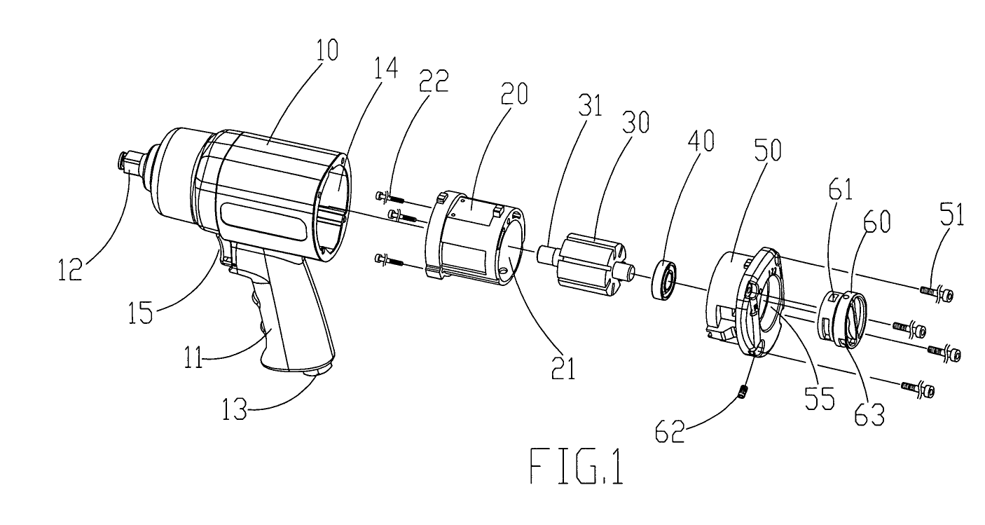

Referring to FIGS. 1 through 3, a preferred embodiment of the invention includes:

a main body 10 having a handle 11, an action end 12, an air inlet 13, a cylinder receptacle 14 and a start switch 15;

a cylinder 20 having a cylinder chamber 21;

an arresting device 30 disposed within the cylinder chamber 21 of the cylinder 20 corresponding to fan blades (not shown), the arresting device 30 having an output shaft 31 extending in axial direction for imparting rotational movement to the action end 12 of the main body 10;

a bearing 40 mounting on a second output shaft opposite to the output shaft of the arresting device;

an air control hood 50 attached to the cylinder 20 by screwing elements 22 and placed into the cylinder receptacle 14 of the main body 10, the air control hood 50 being attached by long screws to the rear side of the cylinder receptacle 14 of the main body 10, thereby fixing the cylinder 20, the arresting device 30 and the bearing 40 in place and sealing the cylinder receptacle 14 of the main body 10, the air control hood 50 further having an air intake channel 52 and two corresponding air guide channels 53, a receiving groove 55 being formed at a rear end of the air control hood 50;

an adjusting knob 60 having an air control channel 61, the adjusting knob 60 being positioned within the receiving groove 55 of the air control hood 50 by use of set screws 62 and restricting recesses 63 so that a certain operation mode can be activated.

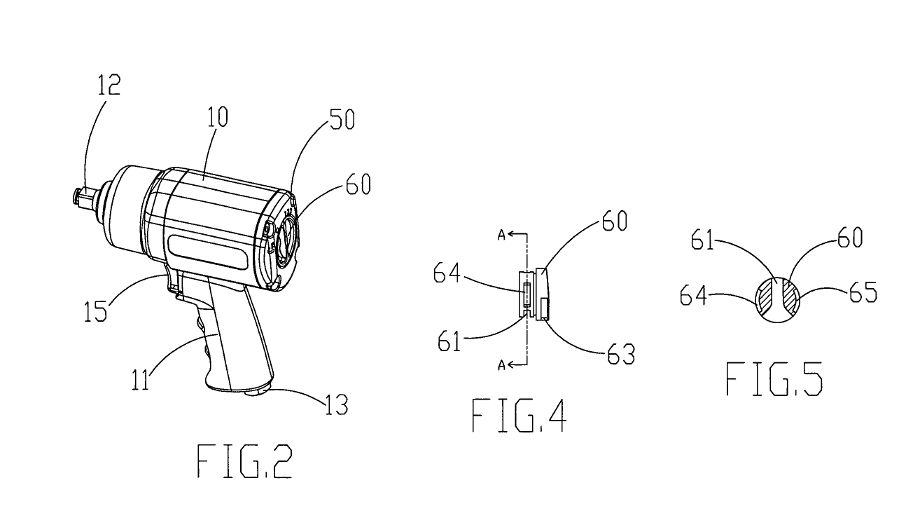

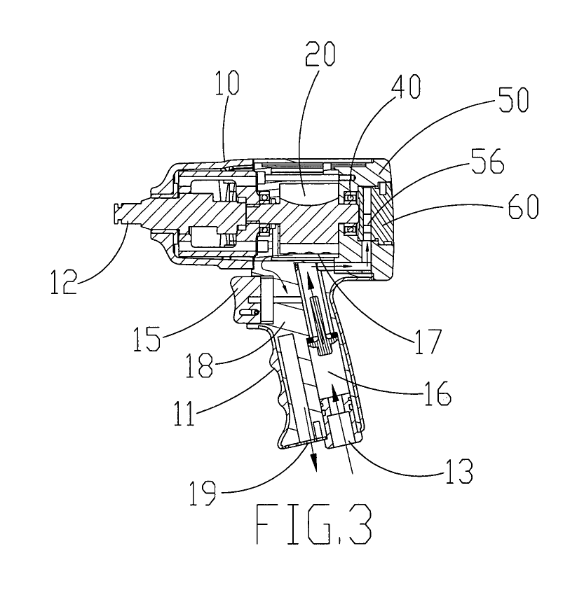

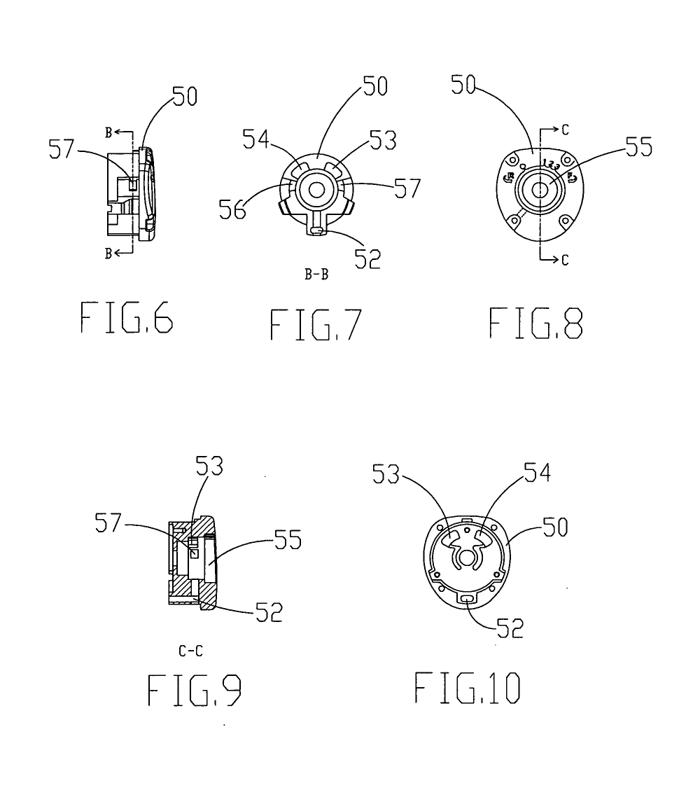

As shown in FIGS. 3 through 10, the control of air intake is performed in such a way that the air flows in the direction shown by arrow through the air inlet 13 of the main body 10 into an air chamber 16 of the handle 11 of the main body 10. Then, it passes through prearranged channels into the air intake channel 52 under the air control hood 50. Thereafter, the air is guided into the air control channel 61 of the adjusting knob 60. In this way, when the adjusting knob 60 is turned such that the air control channel 61 is directed to the first air guide channel 53 or the second air guide channel 54 of the air control hood 50, the air can pass from the desired channel through the air control hood 50 into the cylinder chamber 21 of the cylinder 20. As shown in FIG. 10, the upper blades of the arresting device 30 are exposed to force and therefore driven by wind force in positive or reverse rotation since the first air guide channel 53 and the second air guide channel 54 are positioned at opposing sides.

Particularly, when the first air guide channel 53 is employed for air intake, the second air guide channel 54 is automatically converted for air exhaust. Accordingly, the air escaped from the cylinder chamber 21 will be delivered to a second air exhaust channel 56 located slightly lower than the second air guide channel 54. It is because the second air guide channel 54 and the air control channel 61 are blocked by the adjusting knob 60. In addition, a second guide groove 64 is employed to guide the air to a reserved gap 17 between the cylinder 20 and the cylinder receptacle 14. Thereafter, the air reaches an empty chamber 18 and an air outlet 19 within the handle 11 of the main body 10 for air escape. On the contrary, when the second air guide channel 54 is employed for air intake, the first air guide channel 53 will be automatically converted for air exhaust. Accordingly, the air will be escaped along a route created by a first air exhaust channel 57, a first guide groove 65, the gap 17, the empty chamber 18 and the air outlet 19.

As previously described, the adjusting knob 60 is employed to control the admission and exhaust of air for imparting positive or reverse rotational motion to the arresting device 30. Furthermore, a step-by-step control of the gap between the air control channel 61 and the first air guide channel 53 can be achieved when the arresting device 30 is rotated in positive direction for performing the tightening action of the action end 12. In this way, the air flow rate into the arresting device 30 can be effectively controlled. In brief, this ensures a reliable control over the torsion output of the action end 12. Accordingly, the tightening force on the screw elements (not shown) can be optimally applied without the problem of excessive or insufficient force.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A pneumatic wrench, comprising a main body, a cylinder, an arresting device, a bearing, an air control hood and an adjusting knob,
whereby the air control hood is screwed to a rear side of the cylinder receptacle of the main body, thereby fixing the cylinder, the arresting device and the bearing in place and sealing the cylinder receptacle of the main body, and the air control hood further includes an air intake channel and two corresponding air guide channels that work in cooperation with the adjusting knob having air control channels for controlling the path of and the rate of the air flow in admission into or exhaust out of the cylinder, thereby ensuring an effective control of the rotational direction and torque of an action end of the main body.

2. The pneumatic wrench of claim 1 wherein the air control hood includes a receiving groove at an end facing the adjusting knob.

3. The pneumatic wrench of claim 1 wherein the air control hood includes a first air exhaust channel and a second air exhaust channel located slightly lower than the first air guide channel and the second air guide channel, respectively.

4. The pneumatic wrench of claim 1 wherein the adjusting knob includes a first guide groove and a second guide groove corresponding to the first air exhaust channel and the second air exhaust channel of the air control hood, respectively.
